(19) United States
(12) Patent Application Publication
(10) Pub. No.: US 2026/0244428 A1
(43) Pub. Date: Aug. 20, 2026

(54) MANAGING DYNAMIC FIRMWARE COMPONENTS IN AN SPI-LESS ENVIRONMENT FROM A CLOUD REPOSITORY

(71) Applicant: American Megatrends International, LLC, Duluth, GA (US)

(72) Inventors: Chitrak Gupta, Johns Creek, GA (US); Varadachari Sudan Ayanam, Suwanee, GA (US)

(21) Appl. No.: 19/055,054

(22) Filed: Feb. 17, 2025

(51) Int. Cl. G06F 8/65

(52) U.S. Cl. CPC G06F 8/65

(57) ABSTRACT

In an aspect of the disclosure, a method, a computer-readable medium, and an apparatus are provided. The apparatus may be a BMC. The BMC receives one or more firmware components from a cloud firmware store. These firmware components are intended for execution by a device in a computer system. The BMC stores the one or more firmware components in at least one of: a device attached memory (DAM) of the device, or a shared memory accessible by the device. The BMC provides memory location information to the device. This memory location information indicates where the one or more firmware components are stored in the DAM or the shared memory.

### BACKGROUND

### Field

The present disclosure relates generally to computer systems, and more particularly, to techniques of managing firmware components in modular hardware systems through cloud-based distribution and in-memory execution.

### Background

The statements in this section merely provide background information related to the present disclosure and may not constitute prior art.

Considerable developments have been made in the arena of server management. An industry standard called Intelligent Platform Management Interface (IPMI), described in, e.g., “IPMI: Intelligent Platform Management Interface Specification, Second Generation,” v. 2.0, Feb. 12, 2004, defines a protocol, requirements and guidelines for implementing a management solution for server-class computer systems. The features provided by the IPMI standard include power management, system event logging, environmental health monitoring using various sensors, watchdog timers, field replaceable unit information, in-band and out of band access to the management controller, SNMP traps, etc.

A component that is normally included in a server-class computer to implement the IPMI standard is known as a Baseboard Management Controller (BMC). A BMC is a specialized microcontroller embedded on the motherboard of the computer, which manages the interface between the system management software and the platform hardware. The BMC generally provides the “intelligence” in the IPMI architecture.

The BMC may be considered as an embedded-system device or a service processor. A BMC may require a firmware image to make them operational. “Firmware” is software that is stored in a read-only memory (ROM) (which may be reprogrammable), such as a ROM, programmable read-only memory (PROM), erasable programmable read-only memory (EPROM), electrically erasable programmable read-only memory (EEPROM), etc.

Further, in embedded systems and server environments, firmware is typically stored in Serial Peripheral Interface (SPI) flash memory components. The SPI flash serves as non-volatile storage for the firmware that controls system initialization, hardware management, and various platform functions. For embedded controllers like Baseboard Management Controllers (BMCs), the firmware is loaded from SPI flash during system boot and copied into RAM for execution. This architecture has been widely adopted as it provides persistent storage of firmware code and configuration data that survives power cycles.

However, the SPI flash-based approach presents several technical challenges. The process of updating firmware requires careful programming of the flash memory while following strict security protocols and firmware validation measures. SPI flash components are susceptible to corruption which can prevent system boot, and they require specific register configurations that add complexity during development and porting. Additionally, the fixed capacity of SPI flash places constraints on firmware size and functionality as new features are added over time. The permanent nature of data stored in SPI flash also creates security vulnerabilities if proper encryption and protection mechanisms are not implemented.

In data center environments, server platforms are increasingly adopting modular hardware architectures as specified by initiatives like the Open Compute Project (OCP). These modular designs allow components like processors, storage devices, and management controllers to be individually upgraded without replacing entire systems. The Data Center Ready-Modular Hardware System (DC-MHS) specification defines key components like the Data Center Security and Control Module (DC-SCM) that contains the BMC and Hardware Root of Trust. While this modularity provides hardware flexibility, the traditional SPI flash-based firmware architecture creates challenges for dynamically managing and updating firmware across changing hardware configurations

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a BMC. The BMC receives one or more firmware components from a cloud firmware store. These firmware components are intended for execution by a device in a computer system. The BMC stores the one or more firmware components in at least one of: a device attached memory (DAM) of the device, or a shared memory accessible by the device. The BMC provides memory location information to the device. This memory location information indicates where the one or more firmware components are stored in the DAM or the shared memory.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating a computer system including a baseboard management controller (BMC) and a host computer.

FIG. 2 is a diagram illustrating a modular hardware system including a Data Center Security and Control Module (DC-SCM) and a Host Processor Module (HPM).

FIG. 3 is a diagram illustrating a build orchestrator that includes a discovery service and an update and configuration service.

FIG. 4 is a diagram illustrating an embedded system architecture that utilizes SPI flash storage for firmware.

FIG. 5 is a diagram illustrating a system architecture that enables dynamic firmware management through cloud-based updates and in-memory execution.

FIG. 6 is a diagram illustrating a SPI-less system architecture that enables cloud-based firmware management through device-attached and shared memory.

FIG. 7 is a flow chart of a method for managing firmware in a computer system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of computer systems will now be presented with reference to various apparatus and methods. These apparatus and methods will be described in the following detailed description and illustrated in the accompanying drawings by various blocks, components, circuits, processes, algorithms, etc. (collectively referred to as elements). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a processing system that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

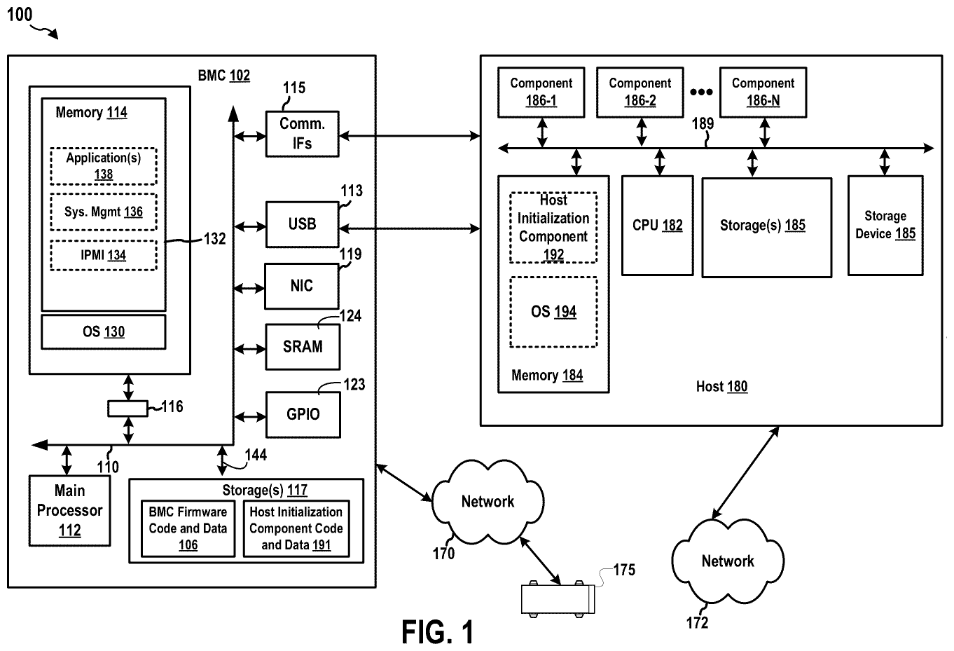

FIG. 1 is a diagram illustrating a computer system 100. In this example, the computer system includes, among other devices, a baseboard management controller (BMC) 102 and a host computer 180. The BMC 102 has, among other components, a main processor 112, a memory 114(e.g., a dynamic random access memory (DRAM)), a memory driver 116, storage(s) 117, a network interface card 119, a USB interface 113 (i.e., Universal Serial Bus), other communication interfaces 115, a SRAM 124 (i.e., static RAM), and a GPIO interface 123(i.e., general purpose input/output interface).

The communication interfaces 115 may include a keyboard controller style (KCS), a server management interface chip (SMIC), a block transfer (BT) interface, a system management bus system interface (SSIF), and/or other suitable communication interface(s). Further, as described infra, the BMC 102 supports IPMI and provides an IPMI interface between the BMC 102 and the host computer 180. The IPMI interface may be implemented over one or more of the USB interface 113, the network interface card 119, and the communication interfaces 115.

In certain configurations, one or more of the above components may be implemented as a system-on-a-chip (SoC). For examples, the main processor 112, the memory 114, the memory driver 116, the storage(s) 117, the network interface card 119, the USB interface 113, and/or the communication interfaces 115 may be on the same chip. In addition, the memory 114, the main processor 112, the memory driver 116, the storage(s) 117, the communication interfaces 115, and/or the network interface card 119 may be in communication with each other through a communication channel 110 such as a bus architecture.

The BMC 102 may store BMC firmware code and data 106 in the storage(s) 117. The storage(s) 117 may utilize one or more non-volatile, non-transitory storage media. During a boot-up, the main processor 112 loads the BMC firmware code and data 106 into the memory 114. In particular, the BMC firmware code and data 106 can provide in the memory 114 an BMC OS 130 (i.e., operating system) and service components 132. The service components 132 include, among other components, IPMI services 134, a system management component 136, and application(s) 138. Further, the service components 132 may be implemented as a service stack. As such, the BMC firmware code and data 106 can provide an embedded system to the BMC 102.

The BMC 102 may be in communication with the host computer 180 through the USB interface 113, the network interface card 119, the communication interfaces 115, and/or the IPMI interface, etc.

The host computer 180 includes a host CPU 182, a host memory 184, storage device(s) 185, and component devices 186-1 to 186-N. The component devices 186-1 to 186-N can be any suitable type of hardware components that are installed on the host computer 180, including additional CPUs, memories, and storage devices. As a further example, the component devices 186-1 to 186-N can also include Peripheral Component Interconnect Express (PCIe) devices, a redundant array of independent disks (RAID) controller, and/or a network controller.

Further, the storage(s) 117 may store host initialization component code and data 191 for the host computer 180. After the host computer 180 is powered on, the host CPU 182 loads the initialization component code and data 191 from the storage(s) 117 though the communication interfaces 115 and the communication channel 110. The host initialization component code and data 191 contains an initialization component 192. The host CPU 182 executes the initialization component 192. In one example, the initialization component 192 is a basic input/output system (BIOS). In another example, the initialization component 192 implements a Unified Extensible Firmware Interface (UEFI). UEFI is defined in, for example, “Unified Extensible Firmware Interface Specification Version 2.6, dated January, 2016,” which is expressly incorporated by reference herein in their entirety. As such, the initialization component 192 may include one or more UEFI boot services.

The initialization component 192, among other things, performs hardware initialization during the booting process (power-on startup). For example, when the initialization component 192 is a BIOS, the initialization component 192 can perform a Power On System Test, or Power On Self Test, (POST). The POST is used to initialize the standard system components, such as system timers, system DMA (Direct Memory Access) controllers, system memory controllers, system I/O devices and video hardware (which are part of the component devices 186-1 to 186-N). As part of its initialization routine, the POST sets the default values for a table of interrupt vectors. These default values point to standard interrupt handlers in the memory 114 or a ROM. The POST also performs a reliability test to check that the system hardware, such as the memory and system timers, is functioning correctly. After system initialization and diagnostics, the POST surveys the system for firmware located on non-volatile memory on optional hardware cards (adapters) in the system. This is performed by scanning a specific address space for memory having a given signature. If the signature is found, the initialization component 192 then initializes the device on which it is located. When the initialization component 192 includes UEFI boot services, the initialization component 192 may also perform procedures similar to POST.

After the hardware initialization is performed, the initialization component 192 can read a bootstrap loader from a predetermined location from a boot device of the storage device(s) 185, usually a hard disk of the storage device(s) 185, into the host memory 184, and passes control to the bootstrap loader. The bootstrap loader then loads an OS 194 into the host memory 184. If the OS 194 is properly loaded into memory, the bootstrap loader passes control to it. Subsequently, the OS 194 initializes and operates. Further, on certain disk-less, or media-less, workstations, the adapter firmware located on a network interface card re-routes the pointers used to bootstrap the operating system to download the operating system from an attached network.

The service components 132 of the BMC 102 may manage the host computer 180 and is responsible for managing and monitoring the server vitals such as temperature and voltage levels. The service stack can also facilitate administrators to remotely access and manage the host computer 180. In particular, the BMC 102, via the IPMI services 134, may manage the host computer 180 in accordance with IPMI. The service components 132 may receive and send IPMI messages to the host computer 180 through the IPMI interface.

Further, the host computer 180 may be connected to a data network 172. In one example, the host computer 180 may be a computer system in a data center. Through the data network 172, the host computer 180 may exchange data with other computer systems in the data center or exchange data with machines on the Internet.

The BMC 102 may be in communication with a communication network 170 (e.g., a local area network (LAN)). In this example, the BMC 102 may be in communication with the communication network 170 through the network interface card 119. Further, the communication network 170 may be isolated from the data network 172 and may be out-of-band to the data network 172 and out-of-band to the host computer 180. In particular, communications of the BMC 102 through the communication network 170 do not pass through the OS 194 of the host computer 180. In certain configurations, the communication network 170 may not be connected to the Internet. In certain configurations, the communication network 170 may be in communication with the data network 172 and/or the Internet. In addition, through the communication network 170, a remote device 175 may communicate with the BMC 102. For example, the remote device 175 may send IPMI messages to the BMC 102 over the communication network 170. Further, the storage(s) 117 is in communication with the communication channel 110 through a communication link 144.

Original Equipment Manufacturers (OEMs), Original Design Manufacturers (OEMs), and Cloud Service Providers (CSPs) move towards a modular hardware architecture in their server platforms. Open Compute Project (OCP) details the modularization criteria through its server hardware specifications. The idea behind this approach is to create a hardware ecosystem that is flexible, scalable, and easily upgradable, aligning with the rapid pace of technology advancements in server components.

The Data Center Ready-Modular Hardware System (DC-MHS) specification outlines the essential components of a modular platform. Key to this architecture is the facility it provides for CSPs and OEMs to upgrade existing systems without the need to invest in entirely new server platforms. The components within the servers, such as processors, storage devices, and management controllers, are designed to be replaceable or upgradable as individual units. This approach significantly reduces the Total Cost of Ownership (TCO) for the organizations, as components can be updated or replaced as needed, without a full system overhaul.

A DC-MHS includes a Data Center Security and Control Module (DC-SCM). The DC-SCM is a compact module designed as a daughter card to be integrated onto a server motherboard. The DC-SCM encapsulates several critical management functionalities that are central to the operation and integrity of the server system. The DC-SCM's infrastructure allows it to be easily swapped out or upgraded without the necessitation of replacing the entire server.

The DC-SCM includes a BMC stack. The BMC stack is responsible for the monitorization of the server's hardware state, facilitating remote management capabilities such as power control, system restoration, and logging. The BMC supports the server's lifecycle by providing diagnostic tools, the ability to update firmware, and manage hardware settings even when the server OS is not running. The modularity of BMC within the DC-SCM means that, as server management needs evolve or as new BMC technology gets introduced, the BMC functionality can be updated or replaced independent of other hardware components.

The DC-SCM includes a Hardware Root of Trust (ROT). The ROT is essentially a trusted source of verification for software and firmware loads on the server, establishing a baseline of trust for all operations. It ensures that only signed, verified code is executed on startup to prevent unauthorized firmware from compromising server integrity.

The ROT mechanism functions as the root for all trust chains on the server, and integrating it within the DC-SCM enables a secure boot process.

The DC-MHS further includes a Host Processor Module (HPM). The HPM functions as the ‘brain’ of the system, hosting processors such as CPUs (Central Processing Units), GPUs (Graphics Processing Units), IPUs (Infrastructure Processing Units), DPUs (Data Processing Units), and accompanying DIMMs (Dual Inline Memory Modules) to provide computing and processing capabilities necessary for running applications and managing workloads.

With the modular approach of DC-MHS, the HPM, including its various processor types and memory, becomes a replaceable unit within the server architecture. Such modularity permits on-the-fly upgrades of the HPM to adapt to new technologies, workloads, or performance goals without the need for comprehensive system replacement. From swapping an outdated CPU to a more powerful one or adding high-capacity DIMMs, the HPM acts as an interchangeable module, facilitating seamless transitions and continuous performance optimization.

The DC-MHS also includes Modular I/O (DC-MIO). The DC-MIO deals with the varied input/output requirements of modern data centers, encapsulating subsystems for storage, network interface cards (NICs), accelerators, and a range of interconnect technologies. These modular components are utilized for a server's connectivity and throughput capabilities to specific workload demands.

The DC-MHS also utilizes SMART Network Interface Cards (NICs) and Data Plane technologies. SMART-NICs are advanced network cards with built-in processors-often based on Field-Programmable Gate Array (FPGA) technology or specific multicore CPUs-that can offload processing tasks from the server's central processing units (CPUs). These network interface cards enable sophisticated processing at the network edge, closer to where data is entering or leaving the server. This form of processing enables efficient data plane operations-those tasks concerned with the forwarding of data packets through the network.

The modular architecture of the DC-MHS improves server upgradeability and system management.

The DC-MHS utilizes modular hardware, enabling easy replacement of components and facilitating easy upgrades. Individual components of the DC-MHS, such as the Host Processor Module (HPM), the DC-SCM, and the Modular I/O, can be interchanged without the requirement of overhauling the entire server infrastructure.

Changes in the HPM can result in the creation of entirely new systems. An HPM upgrade, such as the replacement of a CPU with a more advanced variant, transforms the system's capabilities, aligning it with current performance requisites or specific computational needs.

Changes to platform devices necessitate dynamic firmware capabilities, to ensure that upgrades or alterations in hardware are adequately supported by the system's software. An adaptable firmware framework can respond to changes in the HPM or other components, thus maintaining the integrity and functionality of the server's operations. The adaptable firmware framework serves this purpose by dynamically constructing firmware images tailored to the new configuration.

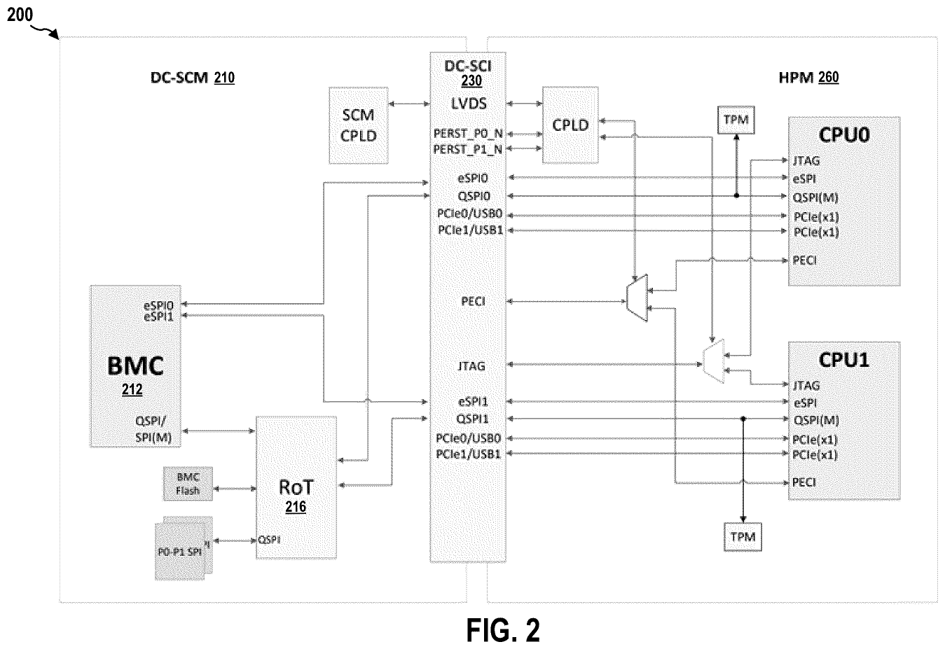

FIG. 2 is a diagram illustrating a modular hardware system 200. The modular hardware system 200 includes a DC-SCM 210, a HPM 260. The DC-SCM 210 includes a BMC 212 and HROT 216, and a Data Center System Connection Interface (DC-SCI) 230. The HPM 260 includes a CPU0 and a CPU1. The DC-SCM 210 and the HPM 260 are connected via the DC-SCI 230. The DC-SCI 230 serves as the foundational communication backbone connecting the Data Center Security and Control Module (DC-SCM) 210 with the Host Processor Module (HPM) 260. It is equipped with a variety of interfaces and protocols designed to ensure a seamless and efficient data flow between the various server modules.

In the modular hardware system 200, the BMC 212 is part of the DC-SCM 210 and adheres to the specifications of the DC-SCM 210. As a replaceable unit within the DC-SCM 210, the BMC 212 may be transitioned between different BMC System-on-Chip (SOC) components provided by the OEMs and CSPs. Deployable firmware images may be supplied for these BMC modules. That is, the firmware is as interchangeable as the hardware components it manages. For example, the OpenBMC firmware is often used.

The Host Processor Module (HPM) may change in a DC-MHS system. In the example of FIG. 2, the HPM 260 functions as the computing module or “brain” of the modular hardware system 200, hosting processors such as CPUs and GPUs along with memory. If the HPM 260 is upgraded or swapped out, it essentially changes the platform, as a new compute module is introduced. For example, the CPU0 and CPU1 in the existing HPM 260 could be replaced with a newer generation processor. The DC-SCI 230 provides standardized connectivity between the HPM and other modules such as the DC-SCM 210, abstracting low-level interface details. However, the BMC 212 in the DC-SCM 210 still needs awareness of the physical interfaces provided by a new HPM for proper management and monitoring. The BMC 212, residing in the DC-SCM 210, recognizes these changes and interacts appropriately with the new physical interfaces provided by the altered HPM.

The BMC 212 encapsulated in the DC-SCM 210 may also change. As a replaceable daughter card unit, an outdated BMC 212 SOC component could be upgraded to a newer generation BMC SOC with different firmware requirements. Customers utilizing a BMC firmware stack require the flexibility to tailored BMC firmware images may be built and deployed for any SOC and platform combination that may arise from BMC swaps. That is, the necessary BMC firmware may be generated on-the-fly to accommodate both the SOC and platform configurations. The BMC image should also inherit necessary configurations from the previous BMC while seamlessly supporting the new module.

Device configurations in the modular hardware system 200 are expected to change over time due to hardware lifecycle management involving addition, removal, or upgrades of devices. The BMC firmware has capabilities to dynamically handle such changes in devices and sensors, discovering new devices added and managing them appropriately. The BMC 212 can handle device changes occurring.

The DC-SCI 230, as the primary conduit for communication and interaction among the modular components of the DC-MHS, adheres to a set standard specification. This standardization ensures that, despite the mutable nature of the aforementioned elements (HPM, BMC, and device configurations), the foundational interconnectivity remains consistent and reliable. The DC-SCI 230's role is to provide a stable and secure platform upon which these interchangeable components can operate cohesively.

In the modular hardware system 200 shown in FIG. 2, the DC-SCM 210 and HPM 260 are separate replaceable modules connected via the DC-SCI 230 interface. As discussed, the HPM 260 as the compute module can be swapped out or upgraded, essentially changing the platform. Similarly, the BMC 212 within the DC-SCM 210 is a replaceable daughter card unit that can also be changed to a newer generation BMC SOC.

To handle such mutable components and platforms, the BMC firmware also has portability. The firmware is configurable to support any alterations occurring in modules of the modular hardware system 200 such as the HPM 260 or BMC 212. For example, if the HPM 260 is swapped from one processor to another, the firmware of the BMC 212 can dynamically handle the new physical interfaces and devices presented by the changed HPM module.

Further, if the BMC 212 itself is upgraded to a newer SOC generation with different firmware requirements, the modular approach allows tailored BMC firmware images to be constructed on-the-fly based on both the new SOC and platform combination. A build orchestration system maintains repositories of SOC drivers, bootloaders, porting components etc. that can be pulled in dynamically to generate firmware images compatible with the new configurations. This firmware portability allows the BMC 212 to adapt to changes in the modular hardware system 200.

The BMC firmware architecture is a framework that includes Intellectual Properties (IP) and abstraction layers that cater to various silicon (i.e., processors) providers (e.g., Intel, AMD, NVIDIA, Qualcomm, and ARM).

These components of the BMC firmware architecture enable the firmware to dynamically handle each unique platform configuration, such as when the BMC 212 interfaces the HPM 260 whose components have been changed.

When BMC hardware upgrade happens by replacing the BMC 212 with a newer generation BMC System-on-Chip (SOC), a tailored BMC firmware image is loaded on the new module to minimize server downtime.

To enable rapid roll-out of firmware, the Build Orchestrator system maintains repositories of pre-built components such as kernel, bootloaders, configuration files etc. for various BMC SOCs.

When the BMC 212 SOC is changed, the Build Orchestrator identifies the target hardware and injects the appropriate meta-layer into the build process to generate firmware with relevant kernel, drivers, libs suited to the new BMC chip. Additionally, Platform Configuration Capsules store modular device configurations needed for discovery and sensor management on that specific server platform. By bringing together these hardware-specific modules at build time, the orchestration system can synthesize a customized, production-grade BMC image for deployment on the new DC-SCM BMC card. Thus, the configurable modular architecture enables rapid roll-out of tailored firmware to support hardware upgrades in line with the dynamic nature of modular platforms.

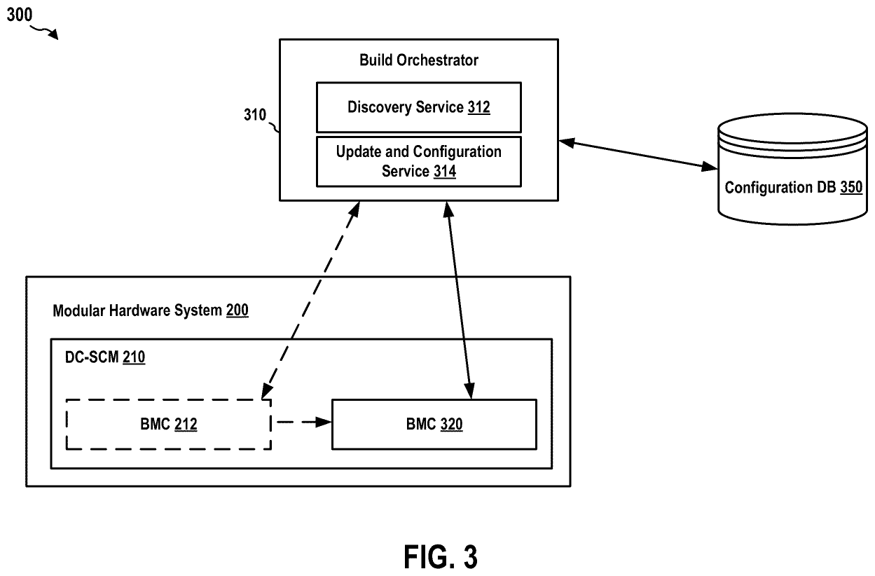

FIG. 3 is a diagram 300 illustrating a build orchestrator 310. The build orchestrator 310 includes a discovery service 312 and an update and configuration service 314, and is in communication with a configuration database 350.

The build orchestrator 310 automates the process of constructing firmware images that are tailored to the specific configurations of the modular hardware system 200's hardware. The build orchestrator 310 may continuously monitor the modular hardware system 200 for any events that signal changes in the hardware configuration. These changes may involve the HPM 260, which includes CPU0 and CPU1, or the BMC 212 embedded within the DC-SCM 210. When such an event is detected, the build orchestrator 310 is responsible for initiating a build process that assembles a new firmware image compatible with the updated hardware setup.

An orchestration process executed by the build orchestrator 310 involves managing a repository of firmware components, which includes drivers, bootloaders, and platform-specific configurations. The build orchestrator 310 uses this repository to put together a firmware image that aligns with the new configuration of the system's hardware. Once the firmware image is constructed, the build orchestrator 310 oversees its deployment to the BMC 212, which may require the BMC to enter flash mode for the firmware update and subsequently reboot the system to apply the new configuration.

Additionally, the build orchestrator 310 provides an Application Programming Interface (API) that enables the BMC 212 to communicate hardware changes and request the generation of new firmware images. This API facilitates automated interactions between the BMC 212 and the build orchestrator 310, allowing for real-time updates and modifications to the firmware in response to changes within the hardware system.

In this example, the BMC 212 of the modular hardware system 200 is replaced with a BMC 320. The build orchestrator 310, with its two primary services—a) the discovery service 312 and b) the update and configuration service 314, manages the firmware to align with this modular approach.

The discovery service 312 is responsible for discovering BMCs within the network. Once a BMC (e.g., initially the BMC 212) is discovered in the network, the discovery service 312 creates a data entry in a configuration database 350. The data entry encompasses details such as platform inventory, BMC SOC type, firmware versions, and generates a JSON configuration file with relevant platform, BMC, and device attributes.

Subsequently, the update and configuration service 314 obtains the device information of the BMC 212 from the configuration database 350. The update and configuration service 314 compares the device configuration of the BMC 212 with the device configuration of the BMC 320 to determine whether any additional changes need to be made to the firmware of the BMC 320.

If a newer version of firmware for the BMC 320 is available, the update and configuration service 314, initiates a new build for the BMC 320 with the platform configuration. Similarly, the build orchestrator 310 may build a new firmware for the entire DC-SCM 210 if any other platform modules within the DC-SCM 210 also have been changed.

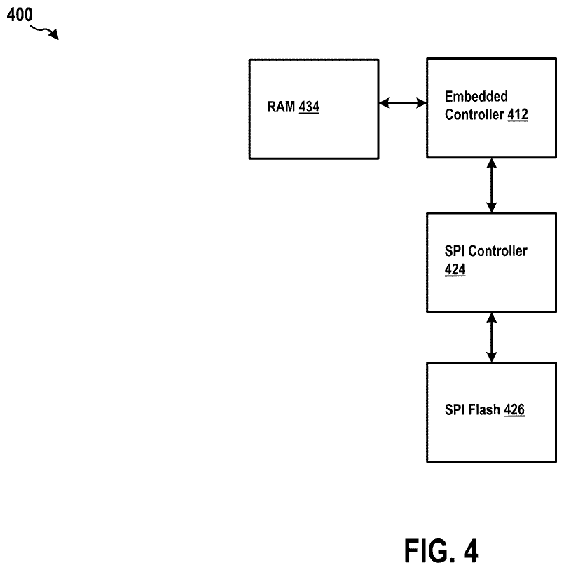

FIG. 4 is a diagram 400 illustrating an embedded system architecture that utilizes SPI flash storage for firmware according to a first scheme. In this example, an embedded controller 412 is connected to a SPI controller 424, which interfaces with a SPI flash 426. The embedded controller 412 is also connected to a RAM 434.

In this first scheme, the SPI flash 426 serves as the primary storage medium for firmware. The embedded controller 412 accesses the firmware stored in the SPI flash 426 through the SPI controller 424. During system operation, the embedded controller 412 loads portions of the firmware from the SPI flash 426 into the RAM 434 for execution.

This architecture presents several technical challenges. When firmware updates are required, the entire process must follow strict security protocols and firmware measurements to maintain system integrity. The update process involves programming the SPI flash 426, which requires careful management of the flash memory sectors and proper handling of register configurations through the SPI controller 424.

The SPI flash 426, being a hardware component, is susceptible to corruption. If corruption occurs, the system may fail to boot, as the embedded controller 412 cannot properly access the firmware stored in the SPI flash 426. Additionally, during system development and porting, engineers must account for various types of SPI flash components and their specific register configurations, adding complexity to the development process.

The permanent nature of data stored in the SPI flash 426 presents security vulnerabilities. Without proper encryption and security measures, the firmware stored in the SPI flash 426 could be compromised, potentially allowing unauthorized access or tampering. Furthermore, the current security architecture involving the platform root of trust makes it challenging to implement dynamic changes, patches, or updates to the existing firmware stored in the SPI flash 426.

The SPI flash 426 also imposes limitations on firmware size and functionality. As new features are added to the firmware, the fixed capacity of the SPI flash 426 can become a constraint, potentially requiring hardware modifications or limiting the ability to add new capabilities to the system.

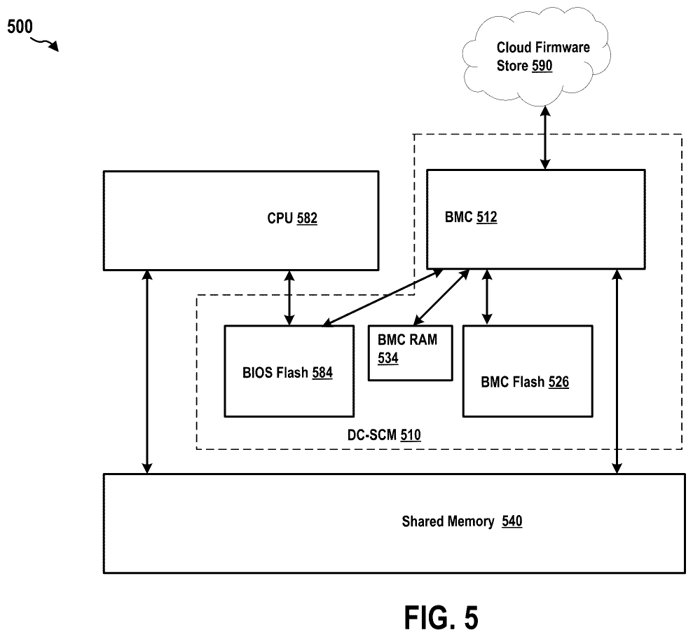

FIG. 5 is a diagram 500 illustrating a system architecture that enables dynamic firmware management through cloud-based updates and in-memory execution. In this architecture, a DC-SCM 510 contains a BMC 512 which communicates with a cloud firmware store 590. The DC-SCM 510 includes the BMC flash 526 and the BMC RAM 534, along with the BIOS flash 584. The system also incorporates a shared memory 540 that facilitates communication between various components.

The architecture addresses limitations of traditional SPI flash-based systems by providing a hybrid approach for firmware management. While the BMC flash 526 maintains a base firmware version (e.g., installed from the factory), the system allows administrators to dynamically load new features and updates from the cloud firmware store 590 into the BMC RAM 534. This approach maintains system stability while enabling flexible feature deployment.

When new firmware features become available in the cloud firmware store 590, the BMC 512 can pull these updates as binary packages. These packages may contain executable binaries, dependent libraries, and configuration files specific to the target device architecture. The BMC 512 loads these components into the BMC RAM 534 and/or the shared memory 540, allowing administrators to test new features without modifying the base firmware in the BMC flash 526.

The system maintains a manifest file that tracks which applications are running in memory. When the system reboots, the BMC 512 references this manifest to automatically reload the necessary binaries from the cloud firmware store 590 into the BMC RAM 534. This mechanism provides persistence for in-memory features across system restarts. The manifest file may be updated each time new features are requested by data center administrators

The architecture supports a CPU 582 that interfaces with both the BIOS flash 584 and the shared memory 540. Through this configuration, the system can coordinate firmware updates between the BMC 512 and other platform components. The shared memory 540 serves as a communication channel between the BMC 512 and the CPU 582, allowing for synchronized firmware management across the platform.

In one example, while the CPU 582 relies on the BIOS flash 584 to load its basic initialization firmware, additional components specific to the platform or to newly introduced CPU features can be downloaded on demand and stored in the shared memory 540. The BMC 512 interprets the manifest to determine which devices require updated binaries, and then either supplies those binaries to the CPU 582 or stores them in memory segments that the CPU 582 can access directly. Security frameworks present in the platform's root of trust infrastructure remain intact, as each new firmware component is validated by the BMC 512 or a hardware trust module before it is placed into memory or flash.

Administrators can monitor system stability through the BMC 512 while running new features from memory. Once they have verified the stability and functionality of new features, they can choose to permanently flash these updates to the BMC flash 526 and/or the BIOS flash 584. This approach reduces risk by allowing extensive testing before committing changes to non-volatile storage.

The system accommodates different processor generations and families through its binary packaging system. The cloud firmware store 590 maintains appropriate binary versions for various hardware configurations, enabling the BMC 512 to pull device-specific updates that match the installed hardware components.

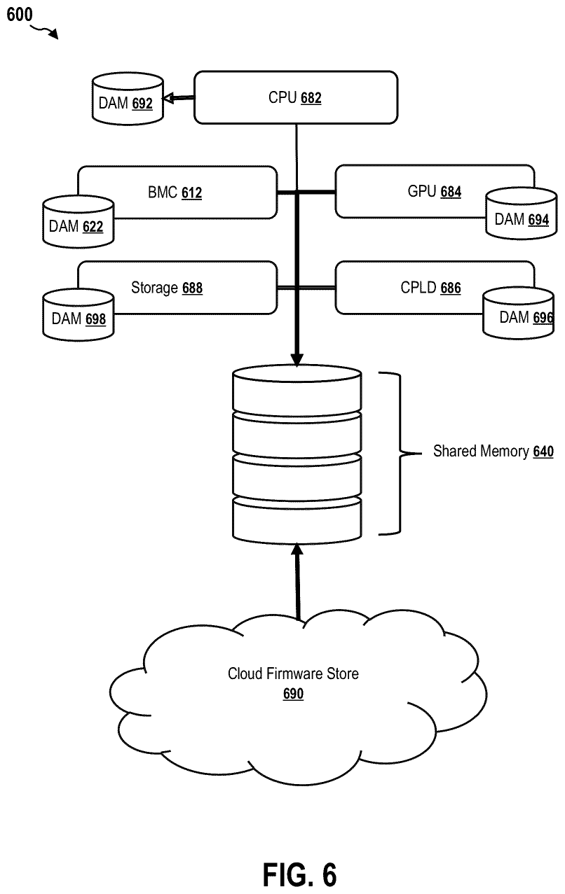

FIG. 6 is a diagram 600 illustrating a SPI-less system architecture that enables cloud-based firmware management through device-attached and shared memory. The system includes a BMC 612, a CPU 682, a GPU 684, a CPLD 686, and a storage 688, each connected to their respective device-attached memories (DAM)-the DAM 622, the DAM 692, the DAM 694, the DAM 696, and the DAM 698. These components are also connected to a shared memory 640, with the system maintaining communication with a cloud firmware store 690.

In this architecture, the traditional SPI flash storage is eliminated, and firmware management is handled through a combination of device-attached memory and shared memory resources. Each hardware component maintains its own device-attached memory, which can store firmware specific to that device. For example, the BMC 612 utilizes the DAM 622 for its firmware storage, while the CPU 682 uses the DAM 692 for its specific firmware needs.

The BMC 612 serves as the primary boot device and coordinates the firmware management process. A minimal bootloader, such as U-Boot, resides in a small ROM partition or a non-volatile random-access memory (NVRAM) section of the DAM 622. This bootloader is programmed with a fixed jump address that points to the firmware loader interface in the shared memory 640.

During the boot process, the BMC 612 initiates communication with the cloud firmware store 690 to fetch the required firmware components and deploy them to the relevant memory regions.

The shared memory 640 functions as a central repository where firmware for various devices can be stored and accessed. When the BMC 612 retrieves firmware from the cloud firmware store 690, it can either distribute the firmware directly to the appropriate device-attached memory or store it in designated sections of the shared memory 640.

The system supports firmware updates through PLDM commands, where devices can indicate whether they support in-memory boot or require their device-attached memory. For instance, when new firmware is available for the GPU 684, the BMC 612 can download it from the cloud firmware store 690 and either store it in the DAM 694 or allocate space in the shared memory 640, depending on the GPU's capabilities and configuration.

This architecture addresses the limitations of fixed SPI flash storage capacity. The memory allocated for firmware can be dynamically adjusted within the available RAM pool, allowing for expansion from initial allocations of 64 MB up to larger sizes such as 1 GB, based on system requirements. This flexibility enables the addition of new features without the constraints of physical flash storage limitations.

The system particularly suits data center environments where server uptimes typically exceed 99.9%. Since servers rarely undergo complete power cycles, the in-memory firmware storage provides a stable and efficient solution. While the architecture requires firmware to be reloaded from the cloud firmware store 690 during each boot sequence, this trade-off is acceptable given the infrequent nature of server reboots in data center operations.

In one example, after establishing a connection with the cloud platform 690, the BMC 612 initiates the firmware management process. The BMC 612 communicates with the cloud platform 690 to request and retrieve firmware images that are compatible with the system's hardware configuration. The firmware distribution mechanism employs Platform Level Data Model (PLDM) commands to coordinate the update process across various system components.

Each device in the system, such as the CPU 682, the GPU 684, the CPLD 686, and the storage 688, communicates its firmware update capabilities through PLDM commands. These commands allow devices to specify whether they support memory-based boot operations or require a local flash storage component. This information is essential for the BMC 612 to determine the appropriate method for firmware deployment.

For devices that support memory-based boot operations, the BMC 612 implements a flexible approach to firmware storage and execution. Upon receiving the firmware image from the cloud platform 690, the BMC 612 can store the firmware in the shared memory 640, which serves as a central firmware repository, or in the device's dedicated DAM. For example, firmware for the GPU 684 can be stored in either the shared memory 640 or its dedicated DAM 694.

After storing the firmware, the BMC 612 uses PLDM commands to notify the target device about the firmware's location. This notification includes specific memory addresses or offsets that enable the device to locate and execute its firmware. For instance, when updating the CPU 682, the BMC 612 can store the firmware in the DAM 692 and provide the CPU 682 with the necessary memory coordinates through PLDM commands.

For devices that utilize flash-based storage, the BMC 612 follows a different update procedure. The firmware update process adheres to the security and measurement protocols established by the platform's root of trust. The BMC 612 transfers the firmware to the device's flash interface, maintaining the integrity and security requirements of the system.

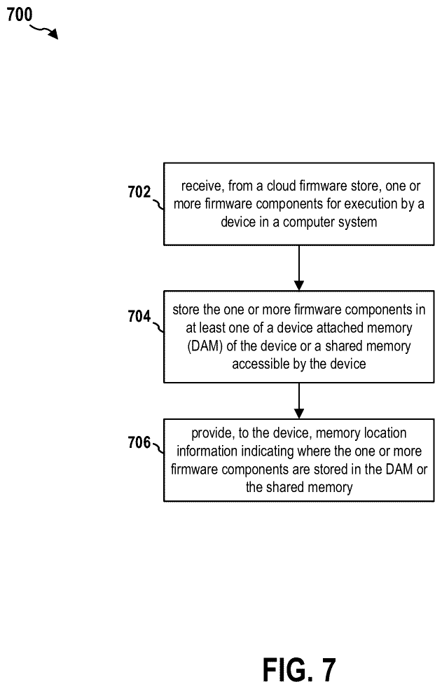

FIG. 7 is a flow chart 700 of a method for managing firmware in a computer system. The method may be performed by a BMC (e.g., the BMC 612). In operation 702, the BMC receives, from a cloud firmware store, one or more firmware components for execution by a device in a computer system. In operation 704, the BMC stores the one or more firmware components in at least one of a device attached memory (DAM) of the device or a shared memory accessible by the device. In operation 706, the BMC provides, to the device, memory location information indicating where the one or more firmware components are stored in the DAM or the shared memory.

The BMC maintains a manifest file tracking which firmware components are running in memory. Upon a system reboot, the BMC automatically reloads the one or more firmware components from the cloud firmware store based on the manifest file. The BMC updates the manifest file when new firmware features are requested by a data center administrator.

In certain configurations, the device comprises at least one of a central processing unit (CPU), a graphics processing unit (GPU), a complex programmable logic device (CPLD), or a storage device.

The BMC receives, from the device via Platform Level Data Model (PLDM) commands, an indication of whether the device supports memory-based boot operations.

The BMC executes a bootloader stored in a read-only memory (ROM) partition or a non-volatile random-access memory (NVRAM) section of a BMC device attached memory. The BMC accesses a firmware loader interface in the shared memory using a programmed jump address stored in the bootloader.

The BMC monitors system stability while the device executes the one or more firmware components from memory. The BMC receives an administrator command to permanently store the one or more firmware components in a non-volatile storage upon verification of system stability.

To receive the one or more firmware components, the BMC receives executable binaries, dependent libraries, and configuration files specific to the device.

The BMC dynamically adjusts memory allocation for the one or more firmware components within an available random access memory (RAM) pool.

The BMC coordinates firmware updates between multiple devices in the computer system using the shared memory as a communication channel.

The BMC validates the one or more firmware components using a hardware trust module before storing the one or more firmware components in memory.

To store the one or more firmware components, the BMC determines a storage location based on device-specific capabilities and configuration requirements.

The BMC retrieves device-specific updates from the cloud firmware store that match installed hardware components in the computer system.

The BMC coordinates distribution of the one or more firmware components to multiple devices using PLDM commands to manage the update process across the multiple devices.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of operation of a baseboard management controller (BMC), comprising:
receiving, from a cloud firmware store, one or more firmware components for execution by a device in a computer system;
storing the one or more firmware components in at least one of a device attached memory (DAM) of the device or a shared memory accessible by the device; and
providing, to the device, memory location information indicating where the one or more firmware components are stored in the DAM or the shared memory.

2. The method of claim 1, further comprising:
maintaining a manifest file tracking which firmware components are running in memory;
upon a system reboot, automatically reloading the one or more firmware components from the cloud firmware store based on the manifest file.

3. The method of claim 2, further comprising:
updating the manifest file when new firmware features are requested by a data center administrator.

4. The method of claim 1, wherein the device comprises at least one of a central processing unit (CPU), a graphics processing unit (GPU), a complex programmable logic device (CPLD), or a storage device.

5. The method of claim 1, further comprising:
receiving, from the device via Platform Level Data Model (PLDM) commands, an indication of whether the device supports memory-based boot operations.

6. The method of claim 1, further comprising:
executing a bootloader stored in a read-only memory (ROM) partition or a non-volatile random-access memory (NVRAM) section of a BMC device attached memory;
accessing a firmware loader interface in the shared memory using a programmed jump address stored in the bootloader.

7. The method of claim 1, further comprising:
monitoring system stability while the device executes the one or more firmware components from memory;
receiving an administrator command to permanently store the one or more firmware components in a non-volatile storage upon verification of system stability.

8. The method of claim 1, wherein receiving the one or more firmware components comprises:
receiving executable binaries, dependent libraries, and configuration files specific to the device.

9. The method of claim 1, further comprising:
dynamically adjusting memory allocation for the one or more firmware components within an available random access memory (RAM) pool.

10. The method of claim 1, further comprising:
coordinating firmware updates between multiple devices in the computer system using the shared memory as a communication channel.

11. The method of claim 1, further comprising:
validating the one or more firmware components using a hardware trust module before storing the one or more firmware components in memory.

12. The method of claim 1, wherein storing the one or more firmware components comprises:
determining a storage location based on device-specific capabilities and configuration requirements.

13. The method of claim 1, further comprising:
retrieving device-specific updates from the cloud firmware store that match installed hardware components in the computer system.

14. The method of claim 1, further comprising:
coordinating distribution of the one or more firmware components to multiple devices using PLDM commands to manage the update process across the multiple devices.

15. A system, including one or more computing devices, comprising:
a memory; and
at least one processor coupled to the memory and configured to:
receive, from a cloud firmware store, one or more firmware components for execution by a device in a computer system;
store the one or more firmware components in at least one of a device attached memory (DAM) of the device or a shared memory accessible by the device; and
provide, to the device, memory location information indicating where the one or more firmware components are stored in the DAM or the shared memory.

16. The system of claim 15, wherein the at least one processor is further configured to:
maintain a manifest file tracking which firmware components are running in memory;
upon a system reboot, automatically reload the one or more firmware components from the cloud firmware store based on the manifest file.

17. The system of claim 16, wherein the at least one processor is further configured to:
update the manifest file when new firmware features are requested by a data center administrator.

18. The system of claim 15, wherein the device comprises at least one of a central processing unit (CPU), a graphics processing unit (GPU), a complex programmable logic device (CPLD), or a storage device.

19. The system of claim 15, wherein the at least one processor is further configured to:
receive, from the device via Platform Level Data Model (PLDM) commands, an indication of whether the device supports memory-based boot operations.

20. A non-transitory computer-readable medium storing computer executable code for operating one or more computing devices, comprising code to:
receive, from a cloud firmware store, one or more firmware components for execution by a device in a computer system;
store the one or more firmware components in at least one of a device attached memory (DAM) of the device or a shared memory accessible by the device; and
provide, to the device, memory location information indicating where the one or more firmware components are stored in the DAM or the shared memory.
